(19) United States
(12) Patent Application Publication
(10) Pub. No.: US 2025/0315625 A1
(43) Pub. Date: Oct. 9, 2025

(54) APPARATUSES, METHODS, AND COMPUTER PROGRAM PRODUCTS FOR GENERATING CLASSIFICATIONS FOR A SERVICE MESSAGE VIA MULTIPLE ARTIFICIAL INTELLIGENCE MODELS

(71) Applicants: ATLASSIAN PTY, LTD., Sydney (AU); ATLASSIAN US, INC., San Francisco, CA (US)

(72) Inventors: Deyang Zhao, San Francisco, CA (US); Zhou Sha, San Francisco, CA (US)

(21) Appl. No.: 19/246,779

(22) Filed: Jun. 24, 2025

Related U.S. Application Data
(63) Continuation of application No. 18/478,145, filed on Sep. 29, 2023.
(60) Provisional application No. 63/377,758, filed on Sep. 30, 2022.

(51) Int. Cl. G06F 40/30; G06Q 30/015

(52) U.S. Cl. CPC G06F 40/30; G06Q 30/015

(57) ABSTRACT

Methods, apparatuses, or computer program products provide for generating classifications for a service message via multiple artificial intelligence (AI) models. In some examples, a service event data structure related to a service message provided to an application framework is received, the service event data structure is input to a first AI model to generate an information technology (IT) support intent classification associated with the service event data structure, the IT support intent classification is compared to execution criteria for a second AI model, the service event data structure is input to the second AI model to generate an escalation classification associated with the service event data structure in response to a determination that the IT support intent classification satisfies the execution criteria, and transmission of a notification for a user device is caused based on the escalation classification.

### CROSS REFERENCE TO RELATED APPLICATIONS

This application is a continuation of and claims priority to U.S. patent application Ser. No. 18/478,145, titled “APPARATUSES, METHODS, AND COMPUTER PROGRAM PRODUCTS FOR TRAINING A VIRTUAL AGENT ARTIFICIAL INTELLIGENCE MODEL,” and filed Sep. 29, 2023, which claims the benefit of U.S. Provisional Patent Application No. 63/377,758, titled “APPARATUSES, METHODS, AND COMPUTER PROGRAM PRODUCTS FOR TRAINING A VIRTUAL AGENT ARTIFICIAL INTELLIGENCE MODEL,” and filed on Sep. 30, 2022, the entireties of which are hereby incorporated by reference.

### BACKGROUND

It is often difficult to manage and/or support components of a server system in which multiple components of the server system interact and/or dynamically change. Through applied effort, ingenuity, and innovation, these identified deficiencies and problems have been solved by developing solutions that are configured in accordance with the embodiments of the present disclosure, many examples of which are described in detail herein.

### BRIEF SUMMARY

In an embodiment, an apparatus comprises one or more processors and one or more storage devices storing instructions that are operable, when executed by the one or more processors, to cause the one or more processors to generate an information technology (IT) support label dataset based on service event data structures related to respective services messages provided to an application framework configured to manage respective application components for IT service management. The instructions are also operable, when executed by the one or more processors, to cause the one or more processors to generate a training dataset associated with a set of candidate questions provided by a classification model. The instructions are also operable, when executed by the one or more processors, to cause the one or more processors to train an artificial intelligence (AI) model based on the IT support label dataset and the training dataset to generate a trained AI model. The instructions are also operable, when executed by the one or more processors, to cause the one or more processors to configure an intent recognition engine for a virtual agent system based on the trained AI model.

In another embodiment, a computer-implemented method provides for generating an IT support label dataset based on service event data structures related to respective services messages provided to an application framework configured to manage respective application components for IT service management. The computer-implemented method also provides for generating a training dataset associated with a set of candidate questions provided by a classification model. The computer-implemented method provides for train an AI model based on the IT support label dataset and the training dataset to generate a trained AI model. The computer-implemented method provides for configuring an intent recognition engine for a virtual agent system based on the trained AI model.

In yet another embodiment, a computer program product is provided. The computer program product is stored on a computer readable medium, comprising instructions that when executed by one or more computers cause the one or more computers to generate an IT support label dataset based on service event data structures related to respective services messages provided to an application framework configured to manage respective application components for IT service management. The instructions, when executed by the one or more computers, also cause the one or more computers to generate a training dataset associated with a set of candidate questions provided by a classification model. The instructions, when executed by the one or more computers, also cause the one or more computers to train an AI model based on the IT support label dataset and the training dataset to generate a trained AI model. The instructions, when executed by the one or more computers, also cause the one or more computers to configure an intent recognition engine for a virtual agent system based on the trained AI model.

Various other embodiments are also described in the following detailed description and in the attached claims.

### BRIEF DESCRIPTION OF THE SEVERAL VIEW OF THE DRAWINGS

Having thus described some embodiments in general terms, references will now be made to the accompanying drawings, which are not drawn to scale, and wherein:

FIG. 1 is a block diagram of an example system within which one or more embodiments of the present disclosure may operate;

FIG. 2 is a block diagram of an example artificial intelligence (AI) model training apparatus configured in accordance with one or more embodiments of the present disclosure;

FIG. 3 illustrates an example system for providing AI model training in accordance with one or more embodiments of the present disclosure;

FIG. 4 illustrates an example user interface in accordance with one or more embodiments of the present disclosure;

FIG. 5 illustrates example AI model(s) in accordance with one or more embodiments of the present disclosure; and

FIG. 6 is a flowchart diagram for training a virtual agent AI model in accordance with one or more embodiments of the present disclosure.

### DETAILED DESCRIPTION OF VARIOUS EMBODIMENTS

Various embodiments of the present disclosure will now be described more fully hereinafter with reference to the accompanying drawings, in which some, but not all embodiments of the present disclosure are shown. Indeed, the disclosure may be embodied in many different forms and should not be construed as limited to the embodiments set forth herein. Rather, these embodiments are provided so that this disclosure will satisfy applicable legal requirements. The term “of” is used herein in both the alternative and conjunctive sense, unless otherwise indicated. The terms “illustrative,” “example,” and “exemplary” are used to be examples with no indication of quality level. Like numbers refer to like elements throughout.

### Overview

Various embodiments of the present disclosure address technical problems associated with efficiently and reliably managing server systems such as, for example, collaborative applications provided via a server system. The disclosed techniques can be provided by an application management apparatus integrated with a distributed ledger system and an application framework system where multiple components/resources and/or layers of components/resources interact with one another in several complex manners to provide collaborative applications and/or collaborative services.

An application framework (e.g., a cloud application framework) is typically characterized by a large number of the application components (e.g., services, micro services, and the like) that are offered by the application framework. One example application framework might include an enterprise instance of Jira®, an action tracking and project management software platform, developed by Atlassian Pty. Ltd. that may be licensed to Beta Corporation. Other software platforms may serve as application frameworks (e.g., Confluence®, Trello®, Bamboo®, Clover®, Crucible®, etc. by Atlassian Pty. Ltd) as will be apparent to one of ordinary skill in the art in view of the foregoing discussion.

Modern application frameworks are designed to possess complex service architectures and are deployed at scale to large enterprise user bases. Because of this scale and the numerosity of the application components, a large number of data objects may be generated by the application framework at most any time interval. These created data objects may be generated for a variety of purposes and can be difficult to track due to the sheer volume data objects and due to the complexity of the application framework. For example, the application framework may be configured as a collaborative service management framework and data objects may be generated as a result of information technology service tickets, information technology service messages, information technology workflow processes and/or other information technology support data provided to the collaborative service management framework.

Data objects generated by an application framework may relate to the application framework itself such as, for example, data objects indicating service tickets, service messages, workflow action, software events, incidents, changes, component requests, alerts, notifications, and/or other data. However, data objects generated by an application framework may also relate to business or enterprise that has deployed or licensed the application framework for managing service tickets, service messages, workflow action, software events, incidents, changes, component requests, alerts, notifications, and/or other data, and the like.

Given the complexity and scale of modern application frameworks, it can be difficult to manage and optimize data requirements and/or computing resources related to application components of such application frameworks. It is generally also difficult to obtain meaningful information related to service tickets, service messages, workflow action, software events, incidents, changes, component requests, alerts, notifications, and/or other data provided to such application frameworks. For example, consider a scenario in which it is desirable for Beta Corporation to manage dynamic or static portions of a services management process such as, for example, an information technology service management process (or another type of application component process) such that service tickets and/or one or more service ticket workflow actions are automatically processed and resolved. However, traditional services management processes and/or workflows often result in a vast collection of unprocessed data, difficult traceability of data, inefficient usage of computing resources, and/or other technical drawbacks.

To address the above-described challenges related to managing server systems, various embodiments of the present disclosure are directed to systems, apparatuses, methods and/or computer program products for training a virtual agent artificial intelligence (AI) model. In one or more embodiments, one or more AI models can be trained to recognize information technology (IT) support intentions related to service tickets, service messages, workflow actions, software events, incidents, changes, component requests, alerts, notifications, and/or other data associated with an application framework. The one or more AI models can be configured as an AI virtual agent engine for the application framework to automate support interactions with respect to the application framework via various communication channels such as a portal, chat, email, web, text, notification, telephone, video, and/or other channels. In various embodiments, a natural language processing engine can be employed to learn from the various communication channels and/or data provided therefrom. In one or more embodiments, the one or more AI models can be configured to interpret intent, context, and/or sentiment related to the support interactions with respect to the application framework.

In various embodiments, the application framework can include components (e.g., application components, application micro-components, services, microservices, etc.) and a workflow event stream associated with the components can be monitored to trigger execution of the AI virtual agent engine. Components of the application framework may include, for example, components related to one or more layers of the application framework. In one or more embodiments, the application framework may facilitate remote collaboration between components. In one or more embodiments, the AI virtual agent engine employs a database associated with workflow event streams to track different and/or service requests. In one or more embodiments, the AI virtual agent engine interacts with components, applications, and/or tools of the application framework to synch data into the database. In one or more embodiments, the AI virtual agent engine is integrated with an event management platform to enable collection of data objects for various workflow event streams. In certain embodiments, predetermined workflow actions can be automatically detected based on monitoring of one or more event streams associated with an application framework. In some embodiments, an Application Programming Interface (API) can be provided to interact with the AI virtual agent engine. For instance, in some embodiments, an API-driven user interface can be provided to enable interaction with the AI virtual agent engine. In one or more embodiments, the user interface provides a visualization related services requests managed by the AI virtual agent engine.

In various embodiments, the support interactions with respect to the application framework can be related to an application component workflow. An application component workflow can represent one or more processes related to a service management application, a project management application, a work management application, a software development application, a product development application, a portfolio management application, a collaborative application, or another type of application provided by an application framework.

By employing the one or more AI models to manage workflows related to an application framework, computing resources and/or memory allocation with respect to processing and storage of data for the application framework can be improved. Additionally, by using the described techniques, various embodiments of the present disclosure provide improved training of a virtual agent AI model that can be used to increase efficiency and/or effectiveness of an application framework system. In doing so, various embodiments of the present disclosure make substantial technical contributions to improving the efficiency and/or the effectiveness of an application framework system. Additionally, in various embodiments, an amount of time to train an AI model can be reduced as compared to traditional AI model training processes by using one or more techniques disclosed herein. Various embodiments of the present disclosure additionally or alternatively provide improved service request support, improved usability, improved data quality, improved interactions, improved processes, improved workflows, improved remote collaborations with respect to workflows related to an application framework. Moreover, various embodiments of the present disclosure additionally or alternatively provide improved AI model performance and/or scaling of a data labeling process for improved training of an AI model.

### Definitions

As used herein, the terms “data,” “content,” “digital content,” “information,” and similar terms may be used interchangeably to refer to data capable of being transmitted, received, and/or stored in accordance with embodiments of the present disclosure. Further, where a computing device is described herein to receive data from another computing device, it will be appreciated that the data may be received directly from another computing device or may be received indirectly via one or more intermediary computing devices, such as, for example, one or more servers, relays, routers, network access points, base stations, hosts, and/or the like, sometimes referred to herein as a “network.” Similarly, where a computing device is described herein to send data to another computing device, it will be appreciated that the data may be sent directly to another computing device or may be sent indirectly via one or more intermediary computing devices, such as, for example, one or more servers, relays, routers, network access points, base stations, hosts, and/or the like.

The terms “computer-readable storage medium” refers to a non-transitory, physical or tangible storage medium (e.g., volatile or non-volatile memory), which may be differentiated from a “computer-readable transmission medium,” which refers to an electromagnetic signal. Such a medium can take many forms, including, but not limited to a non-transitory computer-readable storage medium (e.g., non-volatile media, volatile media), and transmission media. Transmission media include, for example, coaxial cables, copper wire, fiber optic cables, and carrier waves that travel through space without wires or cables, such as acoustic waves and electromagnetic waves, including radio, optical, infrared waves, or the like. Signals include man-made, or naturally occurring, transient variations in amplitude, frequency, phase, polarization or other physical properties transmitted through the transmission media. Examples of non-transitory computer-readable media include a magnetic computer readable medium (e.g., a floppy disk, hard disk, magnetic tape, any other magnetic medium), an optical computer readable medium (e.g., a compact disc read only memory (CD-ROM), a digital versatile disc (DVD), a Blu-Ray disc, or the like), a random access memory (RAM), a programmable read only memory (PROM), an erasable programmable read only memory (EPROM), a FLASH-EPROM, or any other non-transitory medium from which a computer can read. The term computer-readable storage medium is used herein to refer to any computer-readable medium except transmission media. However, it will be appreciated that where embodiments are described to use a computer-readable storage medium, other types of computer-readable mediums can be substituted for or used in addition to the computer-readable storage medium in alternative embodiments.

The terms “client device,” “computing device,” “network device,” “computer,” “user equipment,” and similar terms may be used interchangeably to refer to a computer comprising at least one processor and at least one memory. In some embodiments, the client device may further comprise one or more of: a display device for rendering one or more of a graphical user interface (GUI), a vibration motor for a haptic output, a speaker for an audible output, a mouse, a keyboard or touch screen, a global position system (GPS) transmitter and receiver, a radio transmitter and receiver, a microphone, a camera, a biometric scanner (e.g., a fingerprint scanner, an eye scanner, a facial scanner, etc.), or the like. Additionally, the term “client device” may refer to computer hardware and/or software that is configured to access a component made available by a server. The server is often, but not always, on another computer system, in which case the client accesses the component by way of a network. Embodiments of client devices may include, without limitation, smartphones, tablet computers, laptop computers, personal computers, desktop computers, enterprise computers, and the like. Further non-limiting examples include wearable wireless devices such as those integrated within watches or smartwatches, eyewear, helmets, hats, clothing, earpieces with wireless connectivity, jewelry and so on, universal serial bus (USB) sticks with wireless capabilities, modem data cards, machine type devices or any combinations of these or the like.

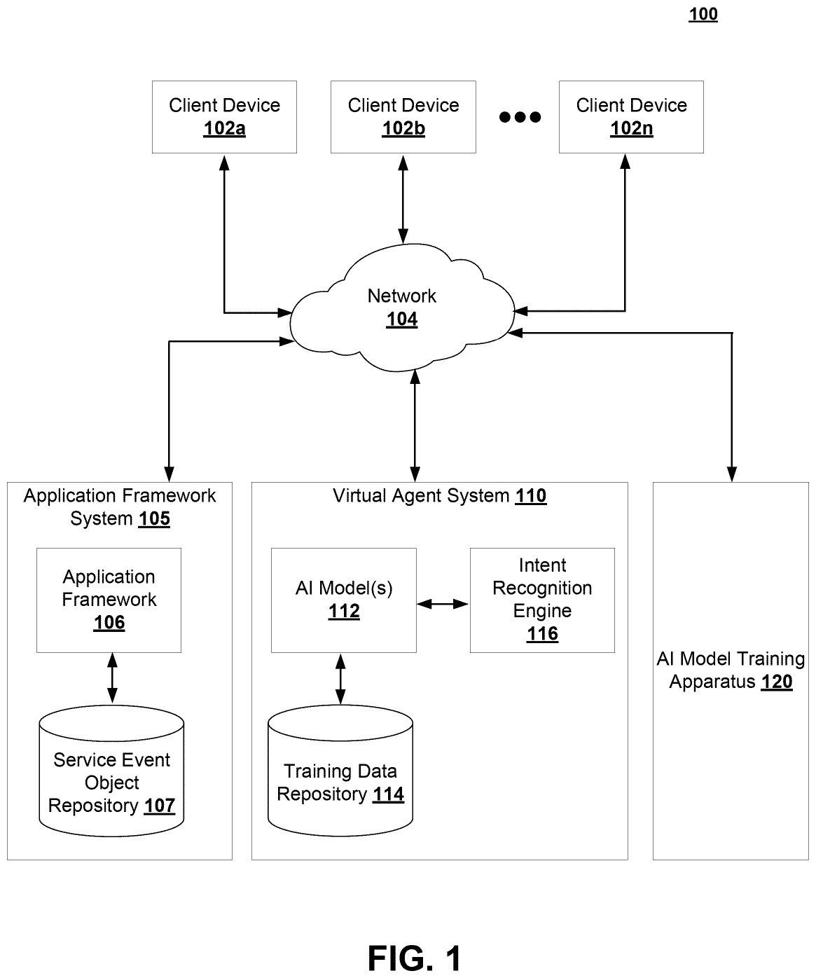

The term “server computing device” refers to a combination of computer hardware and/or software that is configured to provide a component to a client device. An example of a server computing device is the application framework system 105 of FIG. 1. Another example of a server computing device is, in certain embodiments, the virtual agent system 110 of FIG. 1. Another example of a server computing device is, in certain embodiments, the AI model training apparatus 120 of FIG. 1. In some embodiments, a server computing device communicates with one or more client computing devices using one or more computer networks.

The term “circuitry” may refer to: hardware-only circuit implementations (e.g., implementations in analog circuitry and/or digital circuitry); combinations of circuits and one or more computer program products that comprise software and/or firmware instructions stored on one or more computer readable memory devices that work together to cause an apparatus to perform one or more functions described herein; or integrated circuits, for example, a processor, a plurality of processors, a portion of a single processor, a multicore processor, that requires software or firmware for operation even if the software or firmware is not physically present. This definition of “circuitry” applies to all uses of this term herein, including in any claims. Additionally, the term “circuitry” may refer to purpose-built circuits fixed to one or more circuit boards, for example, a baseband integrated circuit, a cellular network device or other connectivity device (e.g., Wi-Fi card, Bluetooth circuit, etc.), a sound card, a video card, a motherboard, and/or other computing device.

The term “application framework” refers to a computing environment associated with one or more computing devices and one or more components (e.g., one or more application components), where the environment enables interactions with respect to components supporting at least one application. For example, an application framework can be a system (e.g., a server system, a cloud-based system, an enterprise system, etc.) where multiple components, multiple resources associated with components, multiple layers of components, and/or multiple layers of resources interact with one another in several complex manners. In some embodiments, the components are associated directly or indirectly with an application supported by the components. In some embodiments, the components can support the application over one or more communication networks. The application framework can include one or more components to generate and update a repository of collected information for each component (e.g., an event object repository). Accordingly, the application framework can provide for the collection of information, in the form of service event objects, to facilitate monitoring of service event streams associated with one or more components of the application framework. In certain embodiments, the application framework can be configured as a service management software platform. In certain embodiments, the application framework can alternatively be configured to manage one or more project management applications, one or more work management applications, one or more software development applications, one or more product development applications, one or more portfolio management applications, one or more collaborative applications, or one or more other types of applications. In certain embodiments, the application framework can be configured as an enterprise instance of an information technology service management software platform. However, it is to be appreciated that, in other embodiments, the application framework can be configured as another type of component platform.

The term “application framework system” refers to a system that includes both a server framework and a repository to support the server framework. For example, an application framework refers to a system that includes a computing environment associated with one or more computing devices and one or more components, as well as a repository of collected information for each component and/or each computing device.

The term “application,” “app,” or similar terms refer to a computer program or group of computer programs designed for use by and interaction with one or more networked or remote computing devices. In some embodiments, an application refers to a mobile application, a desktop application, a command line interface (CLI) tool, or another type of application. Examples of an application comprise workflow engines, component desk incident management, team collaboration suites, cloud components, word processors, spreadsheets, accounting applications, web browsers, email clients, media players, file viewers, videogames, and photo/video editors. An application can be supported by one or more components either via direct communication with the component or indirectly by relying on a component that is in turn supported by one or more other components.

The term “component” or “component application” refers to a computer functionality or a set of computer functionalities, such as the retrieval of specified information or the execution of a set of operations, with a purpose that different clients can reuse for their respective purposes, together with the policies that should control its usage, for example, based on the identity of the client (e.g., an application, another component, etc.) requesting the component. Additionally, a component may support, or be supported by, at least one other component via a component dependency relationship. For example, a translation application stored on a smartphone may call a translation dictionary component at a server in order to translate a particular word or phrase between two languages. In such an example the translation application is dependent on the translation dictionary component to perform the translation task.

In some embodiments, a component is offered by one computing device over a network to one or more other computing devices. Additionally, the component may be stored, offered, and utilized by a single computing device to local applications stored thereon and in such embodiments a network would not be required. In some embodiments, components may be accessed by other components via a plurality of APIs, for example, JavaScript Object Notation (JSON), Extensible Markup Language (XML), Simple Object Access Protocol (SOAP), Hypertext Markup Language (HTML), the like, or combinations thereof. In some embodiments, components may be configured to capture or utilize database information and asynchronous communications via message queues (e.g., Event Bus). Non-limiting examples of components include an open source API definition format, an internal developer tool, web based HTTP components, databased components, and asynchronous message queues which facilitate component-to-component communications.

In some embodiments, a component can represent an operation with a specified outcome and can further be a self-contained computer program. In some embodiments, a component from the perspective of the client (e.g., another component, application, etc.) can be a black box (e.g., meaning that the client need not be aware of the component's inner workings). In some embodiments, a component may be associated with a type of feature, an executable code, two or more interconnected components, and/or another type of component associated with an application framework.

In some embodiments, a component may correspond to a service. Additionally or alternatively, in some embodiments, a component may correspond to a library (e.g., a library of components, a library of services, etc.). Additionally or alternatively, in some embodiments, a component may correspond to one or more modules. Additionally or alternatively, in some embodiments, a component may correspond to one or more machine learning models. For example, in some embodiments, a component may correspond to a service associated with a type of service, a service associated with a type of library, a service associated with a type of feature, a service associated with an executable code, two or more interconnected services, and/or another type of service associated with an application framework.

The term “service” refers to a type of component. In some embodiments, a service provides a visual representation of one or more data structures. In some embodiments, a service is configured for viewing data, searching for data, creating data, updating data, managing relationships among data, assigning attributes related to data, and/or storing data associated with one or more data structures. In some embodiments, a service is configured as a system, tool or product to facilitate viewing data, searching for data, creating data, updating data, managing relationships among data, assigning attributes related to data, and/or storing data associated with one or more data structures. In some embodiments, a service comprises a set of metadata attributes associated with a technical capability, a technical configuration, an application capability, an application configuration, and/or another metadata attribute. In some embodiments, a service is published to one or more client devices via one or more APIs. In some embodiments, a service is a logical representation of an application stack. In some embodiments, a service corresponds to one or more microservices.

The term “microservices” refers to a set of services that are interconnected and independently configured to provide a monolith service. In some embodiments, a microservice is configured with one or more APIs integrated with one or more other microservices and/or one or more other applications. In some embodiments, a microservice is a single-function module with a defined set of interfaces and/or a defined set of operations configured to integrate with one or more other microservices and/or one or more other applications to provide a monolith service.

The term “library” refers to a collection of objects (e.g., a collection of component objects, a collection of service objects, etc.), a collection of functions, and/or a collection of processing threads associated with one or more components.

The term “workflow” refers to a set of actions that represent one or more processes related to an application framework and/or one or more components. A workflow can include a set of statuses and/or a set of transitions that represent one or more processes. For example, a status can represent a state of an action and/or a task performed with respect to an application framework and/or one or more components. A transition can represent a link between status. Actions for a workflow can be configured to dynamically alter a current status of a workflow and/or to initiate a transition.

The term “workflow event” refers to one or more actions, interactions with, and/or one or more changes related to a workflow of an application framework and/or one or more components. In one or more embodiments, a workflow event refers to one or more actions, interactions with, and/or one or more changes related to one or more service management applications, one or more project management applications, one or more work management applications, one or more software development applications, one or more product development applications, one or more portfolio management applications, one or more collaborative applications, or one or more other types of applications. In some embodiments, a workflow event may be associated with metadata, a unique identifier, one or more attributes, one or more features, one or more tags, one or more source identifiers, one or more object types, and/or other context data. In some embodiments, an event may be related to and/or triggered via one or more client devices that interact with one or more components. For example, in some embodiments, a workflow event can be related to one or more service requests initiated via a display screen of a client device. Additionally or alternatively, in some embodiments, a workflow event may be triggered via one or more components and/or one or more user identifiers. In some embodiments, a workflow event may be associated with a workflow event stream.

The term “workflow event stream” refers to a collection of workflow events related to one or more components and/or one or more user identifiers. For example, a workflow event stream can include a first workflow event associated with at least one component, a second workflow event associated with the at least one component, a third workflow event associated with the at least one component, etc. In certain embodiments, a workflow event stream refers to a collection of workflow events related to a service management application, a project management application, a work management application, a software development application, a product development application, a portfolio management application, a collaborative application, or another type of application. In certain embodiments, a workflow event stream can include one or more workflow vector data structures related to one or more workflow events.

The term “user identifier” refers to one or more items of data by which a particular user of the application framework may be uniquely identified. For example, a user identifier can correspond to a particular set of bits or a particular sequence of data that uniquely identifies a user. In various embodiments, a user identifier corresponds to a user that is authorized to view, edit and/or work simultaneously on one or more workflows related to a project management application, a work management application, a service management application, a software development application, a product development application, a portfolio management application, a collaborative application, or another type of application.

The terms “internal component,” “internal resource,” or similar terms refer to a program, application, platform, or component that is configured by a developer to provide functionality to another one or more of their programs, applications, platforms, or components, either directly or indirectly through one or more other components, as opposed to using an external component. Internal components operate on a compiled code base or repository that is at least partially shared by an application which utilizes the functionality provided by the internal component. In some embodiments, the application code base and the internal component code base are hosted on the same computing device or across an intranet of computing devices. An application communicates with internal components within a shared architectural programming layer without external network or firewall separation. In some embodiments, an internal component is used only within the application layer which utilizes the internal components functionality. Information related to internal components can be collected and compiled into component objects which can also be referred to as internal component objects. An example embodiment of an internal component is a load balancer configured for routing and mapping API and/or component locations. Internal components may be configured for information-based shard routing, or in other words, routing and mapping API and/or component locations based on predefined custom component requirements associated with an application. For example, an internal component may be configured to identify where communication traffic originates from and then reply to the communications utilizing another component for reply communication.

The terms “external component,” “external resource,” “remote resource,” or similar terms refer to a program, application, platform, or component that is configured to communicate with another program, application, platform, or component via a network architecture. In some embodiments, communications between an external component and an application calling the external component takes place through a firewall and/or other network security features. The external component operates on a compiled code base or repository that is separate and distinct from that which supports the application calling the external component. The external components of some embodiments generate data or otherwise provide usable functionality to an application calling the external component. In other embodiments, the application calling the external component passes data to the external component. In some embodiments, the external component may communicate with an application calling the external component, and vice versa, through one or more application program interfaces (APIs). For example, the application calling the external component may subscribe to an API of the external component that is configured to transmit data. In some embodiments, the external component receives tokens or other authentication credentials that are used to facilitate secure communication between the external component and an application calling the external component in view of the applications network security features or protocols (e.g., network firewall protocols). An example embodiment of an external component may include cloud components (e.g., AWS®).

The term “service request signal” refers to a signal received by one or more computing devices (e.g., servers, systems, platforms, etc.) which are configured to cause an application framework system to perform one or more actions associated with one or more workflows and/or one or more components of the application framework system. The service request signal may be received via a component management interface, an API, a communication interface, the like, or combinations thereof. In one or more embodiments, the service request signal may be generated by a client device via one or more computer program instructions. In various embodiments, a service request signal can be generated via a service ticket, a service message, a service conversation, a workflow, a collaborative dashboard, a service management application, a project management application, a work management application, a software development application, a product development application, a portfolio management application, a collaborative application, or another type of process related to an application framework. Additionally or alternatively, a service request signal may be cause one or more actions, one or more changes, and/or one or more authorizations with respect to a service ticket, a service message, a service conversation, a workflow, a collaborative dashboard, a service management application, a project management application, a work management application, a software development application, a product development application, a portfolio management application, a collaborative application, or another type of process related to an application framework.

The term “interface element” refers to a rendering of a visualization and/or human interpretation of data associated with an application framework and/or a distributed ledger system. In one or more embodiments, an interface element may additionally or alternatively be formatted for transmission via one or more networks. In one or more embodiments, an interface element may include one or more graphical elements and/or one or more textual elements.

The term “visualization” refers to visual representation of data to facilitate human interpretation of the data. In some embodiments, visualization of data includes graphic representation and/or textual representation of data.

The term “IT support label dataset” refers to one or more labels related to respective IT support classifications. The IT support label dataset may be utilized as a test dataset to evaluate progress of one or more training stages for an AI model. Additionally, the IT support label dataset may be provided via one or more data labeling techniques associated with manual annotation, crowd-sourced labeling, semi-supervised learning, transfer learning, active learning, and/or one or more other data labeling techniques. In certain embodiments, the IT support label dataset may include one or more IT support intent labels related to service events.

The term “service event data structure” refers to a data object for a set of data. In various embodiments, a service event data structure can be a data block or another data item set that stores data and/or metadata associated with a service event. For example, a service event data structure can be configured in accordance with one or more attributes of a service event related to a service message and/or a service ticket provided to an application framework. In one or more embodiments, a service event data structure can include data related to service tickets and/or service messages provided to an application framework.

The term “services message” refers to a communication transmitted and/or received via a portal, chat, email, web, text, notification, telephone, video, and/or other communication channel. A service message may include content data such as text, audio, imagery, video, and/or other content.

The term “training dataset” refers to a set of data utilized to train an AI model. The training dataset may include service event data related to IT support intents, one or more ground truth IT support labels, features for candidate questions provided by a classification model, and/or other training data for utilization during one or more training stages of an AI model.

The term “candidate question” refers to an IT support question that may be related to an IT support request. In one or more embodiments, a candidate question may be correlated to a particular IT support intent. For example, a candidate question may be related to a conversation message with a defined intent. Additionally, a candidate question may be correlated to a defined question class related to one or more defined actions.

The term “classification model” refers to a machine learning classifier configured to determine one or more candidate questions from one or more service event data structures. For example, a classification model may determine one or more candidate question classifications based on features and/or patterns related to one or more service event data structures. The classification model may be configured as a neural network model, a support vector machine, a logistic regression model, a decision tree model, a random forest model, or another type of machine learning model. In some embodiments, the classification model is a term frequency-inverse document frequency (TF-IDF) model.

The term “TF-IDF model refers to a machine learning model that utilizes term frequency and inverse document frequency features and/or patterns related to one or more service event data structures to determine one or more candidate question classifications. In one or more embodiments, a TF-IDF model utilizes natural language processing to determine term frequency and/or inverse document frequency with respect to one or more service event data structures.

In one or more embodiments, the term “AI model” refers to model that utilizes artificial intelligence to provide intent recognition for an intent recognition engine. For example, an AI model may be a deep learning model such as a neural network model (e.g., a deep neural network model) or another type of deep learning model configured for intent recognition. In various embodiments, an AI model may be configured to determine an IT support intent classification (e.g., an IT support label) for service event data.

The term “trained AI model” refers to a trained version of an AI model that has undergone one or more training stages for intent recognition. For example, one or more weights, parameters, hyperparameters, layers, and/or other portions of the trained model may be optimized for predicting intent related to service messages. In one or more embodiments, a trained AI model is configured for employment in a virtual agent system.

The term “intent recognition engine” refers to hardware, software, and/or a combination thereof that utilizes one or more AI models to determine intent related to one or more service signals provided to an application framework system. For example, an intent recognition engine may utilize one or more AI models to determine intent related to one or more service messages provided to an application framework system. In one or more embodiments, an intent recognition engine is a component of a natural language processing system configured to identify IT service intents with respect to service messages.

The term “virtual agent system” refers to a system that includes one or more artificial intelligent models and/or an intent recognition engine to provide interactions with client devices. The interactions with the client devices may include providing information, answering questions, and/or otherwise performing one or more actions based on IT service intents related to service messages. In one or more embodiments, a virtual agent system may output text, audio, imagery, video, and/or other media content related to providing information, answering questions, and/or otherwise performing one or more actions.

Thus, use of any such terms, as defined herein, should not be taken to limit the spirit and scope of embodiments of the present disclosure.

### Example System Architecture

Methods, apparatuses, and computer program products of the present disclosure may be embodied by any of a variety of devices. For example, the method, apparatus, and computer program product of an example embodiment may be embodied by a networked device (e.g., an enterprise platform, etc.), such as a server or other network entity, configured to communicate with one or more devices, such as one or more query-initiating computing devices. Additionally or alternatively, the computing device may include fixed computing devices, such as a personal computer or a computer workstation. Still further, example embodiments may be embodied by any of a variety of mobile devices, such as a portable digital assistant (PDA), mobile telephone, smartphone, laptop computer, tablet computer, wearable, the like or any combination of the aforementioned devices.

FIG. 1 illustrates an example system architecture 100 within which embodiments of the present disclosure may operate. The system architecture 100 includes an application framework system 105 configured to interact with one or more client devices 102a-n, such as client device 102a, client device 102b, and/or client device 102n. In one or more embodiments, the one or more client devices 102a-n may be configured to interact with one or more components managed by an application framework 106 of the application framework system 105. For example, in one or more embodiments, the one or more client devices 102a-n may be configured to send data to the one or more components managed by the application framework 106 and/or receive data from the one or more components managed by the application framework 106. In one or more embodiments, the one or more components can be related to one or more service requests, one or more service tickets, one or more service messages, one or more service conversations, one or more notifications, one or more workflows, a collaborative IT service management document, a collaborative IT service management dashboard, collaborative software management, and/or another type of application provided by the application framework 106.

The system architecture 100 also includes a virtual agent system 110 and/or an AI model training apparatus 120. In an embodiment, the AI model training apparatus 120 is implemented separate from the virtual agent system 110 and the application framework system 105. Alternatively, in certain embodiments, the virtual agent system 110 can include the AI model training apparatus 120. Alternatively, in certain embodiments, the application framework system 105 can include the AI model training apparatus 120. In various embodiments, the virtual agent system 110 and/or the AI model training apparatus 120 can also be configured to interact with the one or more client devices 102a-n. In one or more embodiments, the virtual agent system 110 can include one or more AI models 112, a training data repository 114, and/or an intent recognition engine 116.

The application framework system 105, the virtual agent system 110, the AI model training apparatus 120, and/or the one or more client devices 102a-n may be in communication using a network 104. Additionally or alternatively, in various embodiments, the application framework system 105, the virtual agent system 110, and/or the AI model training apparatus 120 may be in communication via a backend network and/or an enterprise network separate from the one or more client devices 102a-n. The network 104 may include any wired or wireless communication network including, for example, a wired or wireless local area network (LAN), personal area network (PAN), metropolitan area network (MAN), wide area network (WAN), the like, or combinations thereof, as well as any hardware, software and/or firmware required to implement the network 104 (e.g., network routers, etc.). For example, the network 104 may include a cellular telephone, an 802.11, 802.16, 802.20, and/or WiMAX network. Further, the network 104 may include a public network, such as the Internet, a private network, such as an intranet, or combinations thereof, and may utilize a variety of networking protocols now available or later developed including, but not limited to Transmission Control Protocol/Internet Protocol (TCP/IP) based networking protocols. In some embodiments, the protocol is a custom protocol of JSON objects sent via a WebSocket channel. In some embodiments, the protocol is JSON over RPC, JSON over REST/HTTP, the like, or combinations thereof.

A client device from the one or more client devices 102a-n may include a mobile device, a smart phone, a tablet computer, a laptop computer, a wearable device, a personal computer, an enterprise computer, a virtual reality device, or another type of computing device. In one or more embodiments, a client device from the one or more client devices 102a-n includes geolocation circuitry configured to report a current geolocation of the client device. In some embodiments, the geolocation circuitry of the client device may be configured to communicate with a satellite-based radio-navigation system such as the global position satellite (GPS), similar global navigation satellite systems (GNSS), or combinations thereof, via one or more transmitters, receivers, the like, or combinations thereof. In some embodiments, the geolocation circuitry of the client device may be configured to infer an indoor geolocation and/or a sub-structure geolocation of the client device using signal acquisition and tracking and navigation data decoding, where the signal acquisition and tracking and the navigation data decoding is performed using GPS signals and/or GPS-like signals (e.g., cellular signals, etc.). Other examples of geolocation determination include Wi-Fi triangulation and ultra-wideband radio technology.

In one or more embodiments, the application framework system 105 may be configured to receive one or more service request signals from one or more of the client devices 102a-n. A service request signal refers to a signal configured to cause one or more actions with respect to the application framework 106. For example, a service request signal can be a signal configured to cause one or more actions with respect to one or more workflows managed by the application framework 106. A service request signal may be generated by the one or more client devices 102a-n and may be received via a communication channel associated with the application framework 106, a component management interface of the application framework 106, an API of the application framework 106, a communication interface of the application framework 106, the like, or combinations thereof. The communication channel can be related to a portal, chat, email, web, text, notification, telephone, video, and/or other type of communication. Based on the one or more service request signals, the application framework system 105 may perform one or more actions with respect to the application framework 106. In various embodiments, the one or more actions can be associated with one or more workflow events with respect to one or more components of the application framework 106. For example, the one or more actions can initiate and/or correspond to one or more workflow events with respect to one or more components of the application framework 106. In certain embodiments, the one or more actions can be associated with one or more workflow events with respect to one or more service management applications, one or more project management applications, one or more work management applications, one or more software development applications, one or more product development applications, one or more portfolio management applications, one or more collaborative applications, or one or more other types of applications managed by the application framework 106.

In various embodiments, the application framework system 105 may include a service event object repository 107 associated with the one or more events. The service event object repository 107 may store event data for one or more service event objects related to the one or more service request signals provided to the application framework 106. For example, the service event object repository 107 may store data associated with service tickets, service messages, workflow action, software events, incidents, changes, component requests, alerts, notifications, and/or other data. The service event object repository 107 may include one or more storage units, such as multiple distributed storage units that are connected through a computer network. Each storage unit in the service event object repository 107 may store at least one of one or more data assets and/or one or more data about the computed properties of one or more data assets. Moreover, each storage unit in the service event object repository 107 may include one or more non-volatile storage or memory media including but not limited to hard disks, ROM, PROM, EPROM, EEPROM, flash memory, MMCs, SD memory cards, memory sticks, CBRAM, PRAM, FeRAM, NVRAM, MRAM, RRAM, SONOS, FJG RAM, Millipede memory, racetrack memory, the like, or combinations thereof.

In one or more embodiments, the data stored in the service event object repository 107 can be employed by the virtual agent system 110 and/or the AI model training apparatus 120 to train the one or more AI models 112 and/or to execute the intent recognition engine 116. In certain embodiments, at least a portion of training data included in the training data repository 114 can correspond to data from the service event object repository 107.

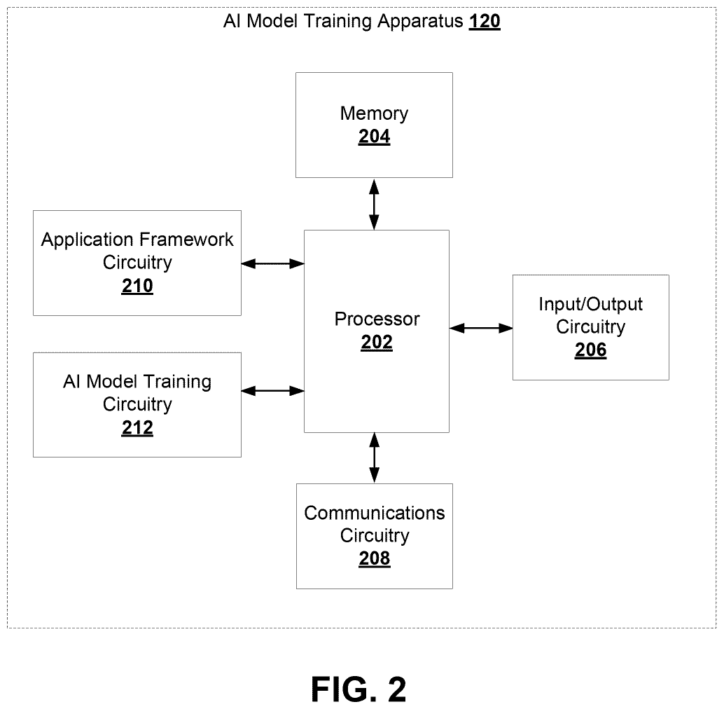

The AI model training apparatus 120 may be embodied by one or more computing systems, such the AI model training apparatus 120 illustrated in FIG. 2. In one or more embodiments, the AI model training apparatus 120 may include processor 202, memory 204, input/output circuitry 206, communications circuitry 208, application framework circuitry 210, and/or AI model training circuitry 212. The AI model training apparatus 120 may be configured to execute the operations described herein. Although these components 202-212 are described with respect to functional limitations, it should be understood that the particular implementations necessarily include the use of particular hardware. It should also be understood that certain of these components 202-212 may include similar or common hardware. For example, two sets of circuitries may both leverage use of the same processor, network interface, storage medium, or the like to perform their associated functions, such that duplicate hardware is not required for each set of circuitries.

In some embodiments, the processor 202 (and/or co-processor or any other processing circuitry assisting or otherwise associated with the processor) may be in communication with the memory 204 via a bus for passing information among components of the apparatus. The memory 204 is non-transitory and may include, for example, one or more volatile and/or non-volatile memories. In other words, for example, the memory 204 may be an electronic storage device (e.g., a computer-readable storage medium). The memory 204 may be configured to store information, data, content, applications, instructions, or the like for enabling the apparatus to carry out various functions in accordance with example embodiments of the present disclosure.

The processor 202 may be embodied in a number of different ways and may, for example, include one or more processing devices configured to perform independently. In some preferred and non-limiting embodiments, the processor 202 may include one or more processors configured in tandem via a bus to enable independent execution of instructions, pipelining, and/or multithreading. The use of the term “processing circuitry” may be understood to include a single core processor, a multi-core processor, multiple processors internal to the apparatus, and/or remote or “cloud” processors.

In some preferred and non-limiting embodiments, the processor 202 may be configured to execute instructions stored in the memory 204 or otherwise accessible to the processor 202. In some preferred and non-limiting embodiments, the processor 202 may be configured to execute hard-coded functionalities. As such, whether configured by hardware or software methods, or by a combination thereof, the processor 202 may represent an entity (e.g., physically embodied in circuitry) capable of performing operations according to an embodiment of the present disclosure while configured accordingly. Alternatively, as another example, when the processor 202 is embodied as an executor of software instructions, the instructions may specifically configure the processor 202 to perform the algorithms and/or operations described herein when the instructions are executed.

In some embodiments, the AI model training apparatus 120 may include input/output circuitry 206 that may, in turn, be in communication with processor 202 to provide output to the user and, in some embodiments, to receive an indication of a user input. The input/output circuitry 206 may comprise a user interface and may include a display, and may comprise a web user interface, a mobile application, a query-initiating computing device, a kiosk, or the like. In some embodiments, the input/output circuitry 206 may also include a keyboard, a mouse, a joystick, a touch screen, touch areas, soft keys, a microphone, a speaker, or other input/output mechanisms. The processor and/or user interface circuitry comprising the processor may be configured to control one or more functions of one or more user interface elements through computer program instructions (e.g., software and/or firmware) stored on a memory accessible to the processor (e.g., memory 204, and/or the like).

The communications circuitry 208 may be any means such as a device or circuitry embodied in either hardware or a combination of hardware and software that is configured to receive and/or transmit data from/to a network and/or any other device, circuitry, or module in communication with the AI model training apparatus 120. In this regard, the communications circuitry 208 may include, for example, a network interface for enabling communications with a wired or wireless communication network. For example, the communications circuitry 208 may include one or more network interface cards, antennae, buses, switches, routers, modems, and supporting hardware and/or software, or any other device suitable for enabling communications via a network. Additionally or alternatively, the communications circuitry 208 may include the circuitry for interacting with the antenna/antennae to cause transmission of signals via the antenna/antennae or to handle receipt of signals received via the antenna/antennae.

The application framework circuitry 210 may be any means such as a device or circuitry embodied in either hardware or a combination of hardware and software that is configured to interact with the application framework system 105. In various embodiments, the application framework circuitry 210 may monitor, analyze, and/or process data associated with the application framework system 105 such as, for example, workflow data stored in the service event object repository 107 and/or data related to a collaborative document. For example, in various embodiments, the application framework circuitry 210 may monitor workflow event streams associated with the application framework 106 to detect respective workflow vector data structures related to components of the application framework 106. In certain embodiments, the application framework circuitry 210 may be configured to retrieve metadata associated with the application framework 106 and/or the service event object repository 107 to facilitate detection of respective workflow vector data structures related to components of the application framework 106. The metadata may include, for example, data associated with relationships, sources, targets, ownership, consumption, libraries, activities, attributes, incidents, actions, workflow events, communication channels, dashboards, data repositories, labels, descriptions, and/or other data related to the application framework 106 and/or the service event object repository 107.

In some embodiments, to facilitate monitoring of workflow event streams, the application framework circuitry 210 can be configured to ping one or more computing devices of the application framework 106, such as via an internet control message protocol, to receive information related to one or more components of the application framework 106. In some embodiments, to obtain event objects associated with the one or more components, the application framework circuitry 210 utilizes the communications circuitry 208 to transmit one or more API calls to one or more API servers associated with the noted client devices.

In some embodiments, the service event object repository 107 may comprise one or more of a single unified repository, a single partitioned repository, or a plurality of isolated repositories comprising one or more partitions. An example embodiment of service event object repository 107 may comprise separate partitions for isolating information for respective user identifiers associated with a defined portion of the training data repository 114. The application framework circuitry 210 may also be configured to generate access logs and/or historical data including information associated with a particular user identifier, computing device, component, the like, or combinations thereof. Historical data may include component activity records for a particular time interval.

The AI model training circuitry 212 may be any means such as a device or circuitry embodied in either hardware or a combination of hardware and software that is configured to interact with the virtual agent system 110. In various embodiments, the AI model training circuitry 212 may be configured to interact with the one or more AI models 112 and/or the training data repository 114. In one or more embodiments, the AI model training circuitry 212 may train the one or more AI models 112 and/or cause execution of the one or more AI models 112 based on training data included in the training data repository 114. The AI model training circuitry 212 may also manage the training data stored in the training data repository 114. For example, the AI model training circuitry 212 may modify the training data repository 114 based on data included in the service event object repository 107 and/or based on service request signals received by the application framework system 105.

In some embodiments, one or more external systems (such as a remote cloud computing and/or data storage system) may also be leveraged to provide at least some of the functionality discussed herein.

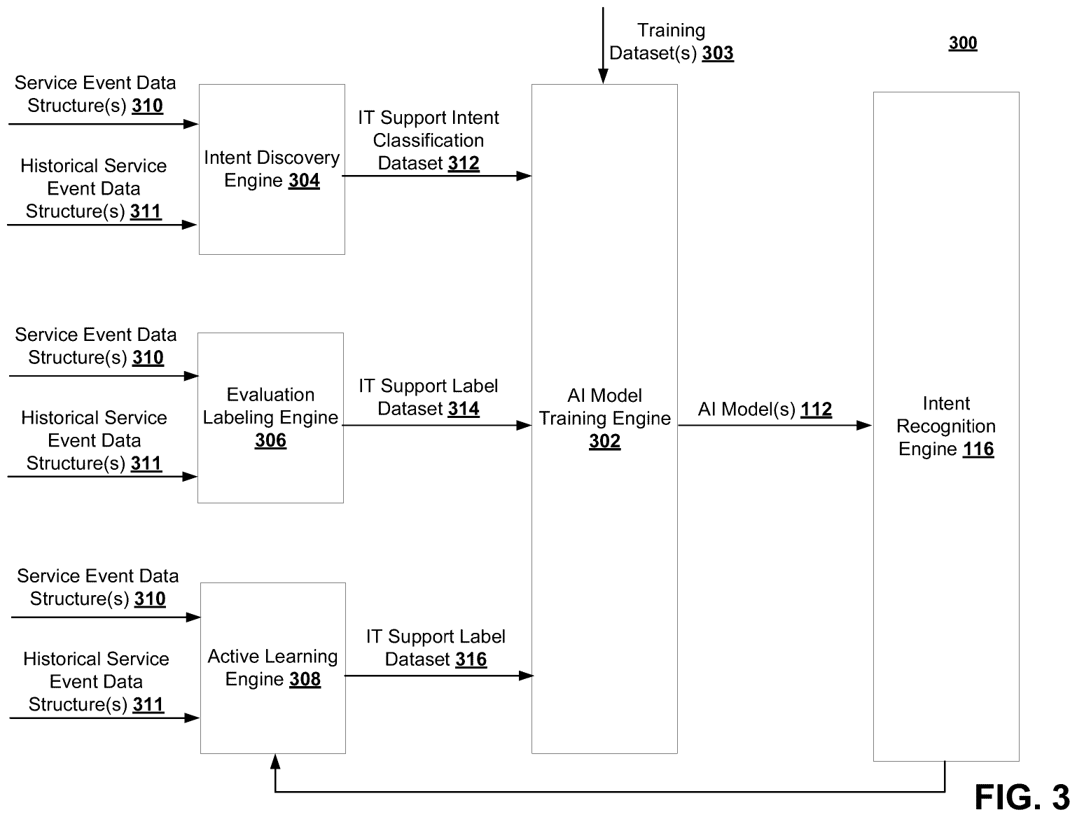

Referring now to FIG. 3, an example system 300 is presented in accordance with one or more embodiments of the present disclosure. The system 300 can be related to one or more processes performed by at least the AI model training apparatus 120. The system 300 includes AI model training engine 302 that is performed by the AI model training apparatus 120 to train the one or more AI models 112. The system 300 also includes the intent recognition engine 116 that can employ the one or more AI models 112 to determine intent related to one or more service signals provided to the application framework system 105. For example, the intent recognition engine 116 can employ the one or more AI models 112 to determine intent (e.g., IT support intentions) related to service tickets and/or service messages provided to the application framework 106.

The AI model training engine 302 can employ data provided by intent discovery engine 304, evaluation labeling engine 306, and/or active learning engine 308 to perform training of the one or more AI models 112. The intent discovery engine 304, the evaluation labeling engine 306, and/or the active learning engine 308 can be configured to receive one or more service event data structures 310. Additionally, the intent discovery engine 304, the evaluation labeling engine 306, and/or the active learning engine 308 can be configured to receive one or more historical service event data structures 311. The one or more service event data structures 310 can include data stored in the service event object repository 107. For instance, the one or more service event data structures 310 can include data related to service tickets and/or service messages provided to the application framework 106. In various embodiments, the one or more service event data structures 310 can respectively include data related to a service conversation that contains a collection of service messages. The service messages can be one or more historical service messages and/or one or more ongoing service messages with respect to the application framework system 105.

The one or more historical service event data structures 311 can also include data stored in the service event object repository 107. For instance, the one or more historical service event data structures 311 can include historical data related to historical service tickets and/or historical service messages provided to an application framework that is different than the application framework 106. Additionally or alternatively, the one or more historical service event data structures 311 can include historical data related to historical service tickets and/or historical service messages provided to the application framework 106. In various embodiments, the one or more historical service event data structures 311 can respectively include historical data related to a historical service conversation that contains a collection of historical service messages. In an embodiment, the one or more historical service event data structures 311 can include data that is different than data of the one or more service event data structures 310. Additionally or alternatively, at least a portion of the data of the one or more historical service event data structures 311 can correspond to data of the one or more service event data structures 310. In various embodiments, the one or more service event data structures 310 and/or one or more training datasets 303 employed by the AI model training engine 302 can be associated with a particular user identifier. For example, a service request signal can be received from a user identifier via a user interface of a client device associated with the user identifier. As such, in certain embodiments, the AI model training engine 302 can uniquely configure training of the one or more AI models 112 based on the particular user identifier.

In certain embodiments, the application framework circuitry 210 of the AI model training apparatus 120 can perform one or more data importing processes to convert certain types of data stored in the service event object repository 107 into the one or more service event data structures 310. For example, the application framework circuitry 210 can convert one or more service management issues related to a service ticket into one or more service messages formatted as data included in the one or more service event data structures 310. In certain embodiments, the application framework circuitry 210 can execute one or more API calls to convert and/or parse one or more service management issues related to a service ticket into one or more service messages.

The intent discovery engine 304 can be configured to perform one or more clustering techniques with respect to the one or more service event data structures 310 and/or the one or more historical service event data structures 311 to generate an IT support intent classification dataset 312. The IT support intent classification dataset 312 can include a classification for respective support request types. For example, the IT support intent classification dataset 312 can include a list of categories related to IT support requests, where the respective categories in the list of categories correspond to a potential issue and/or workflow to resolve the issue. In various embodiments, the intent discovery engine 304 can group service event data (e.g., IT support requests) associated with the one or more service event data structures 310 and/or the one or more historical service event data structures 311 based on similarity (e.g., common intents) to generate respective groups of service event data. Additionally, the intent discovery engine 304 can assign an IT support intent classification to the respective groups based on an inferred IT support intent for the respective groups. For example, the IT support intent classifications can correspond to respective IT support question classes (e.g., QuestionClass1, QuestionClass2, etc.) such that IT support questions in the same IT support question class can comprise a corresponding meaning. In certain embodiments, the intent discovery engine 304 can employ a sentence encoder (e.g., a universal sentence encoder) to perform the one or more clustering techniques and/or to classify data in the one or more service event data structures 310 and/or the one or more historical service event data structures 311. For example, the intent discovery engine 304 can be configured to encode text included in the one or more service event data structures 310 and/or the one or more historical service event data structures 311 into embedding vectors employed for text classification, semantic understanding, clustering, and/or natural language processing.

The evaluation labeling engine 306 can be configured to perform one or more labeling techniques with respect to the one or more service event data structures 310 and/or the one or more historical service event data structures 311 to generate an IT support label dataset 314. In various embodiments, the evaluation labeling engine 306 can employ the IT support intent classification dataset 312 to perform labeling with respect to the one or more service event data structures 310 and/or the one or more historical service event data structures 311. In one or more embodiments, the evaluation labeling engine 306 can randomly sample service event data (e.g., IT support requests) associated with the one or more service event data structures 310 and/or the one or more historical service event data structures 311. Additionally, the evaluation labeling engine 306 can determine a label for the respective service event data (e.g., IT support requests) based on the IT support intent classification dataset 312. In certain embodiments, the IT support label dataset 314 can be employed as a test dataset (e.g., a development dataset) to evaluate progress of the AI model training engine 302. In one or more embodiments, at least a portion of the IT support label dataset 314 can correspond to one or more IT support intent classifications included in the IT support intent classification dataset 312.

In certain embodiments, the AI model training engine 302 can compare the IT support intent classification dataset 312 and the IT support label dataset 314 to determine a common set of classifications and/or labels for training the one or more AI models 112. For example, the AI model training engine 302 can compare the IT support intent classification dataset 312 and the IT support label dataset 314 based on one or more quality metrics associated with accuracy and/or precision of IT support intent classifications and labels respectively provided by the intent discovery engine 304 and the evaluation labeling engine 306. In various embodiments, the AI model training engine 302 can select one or more IT support labels for the one or more training datasets 303 based on the comparison between the IT support intent classification dataset 312 and the IT support label dataset 314.

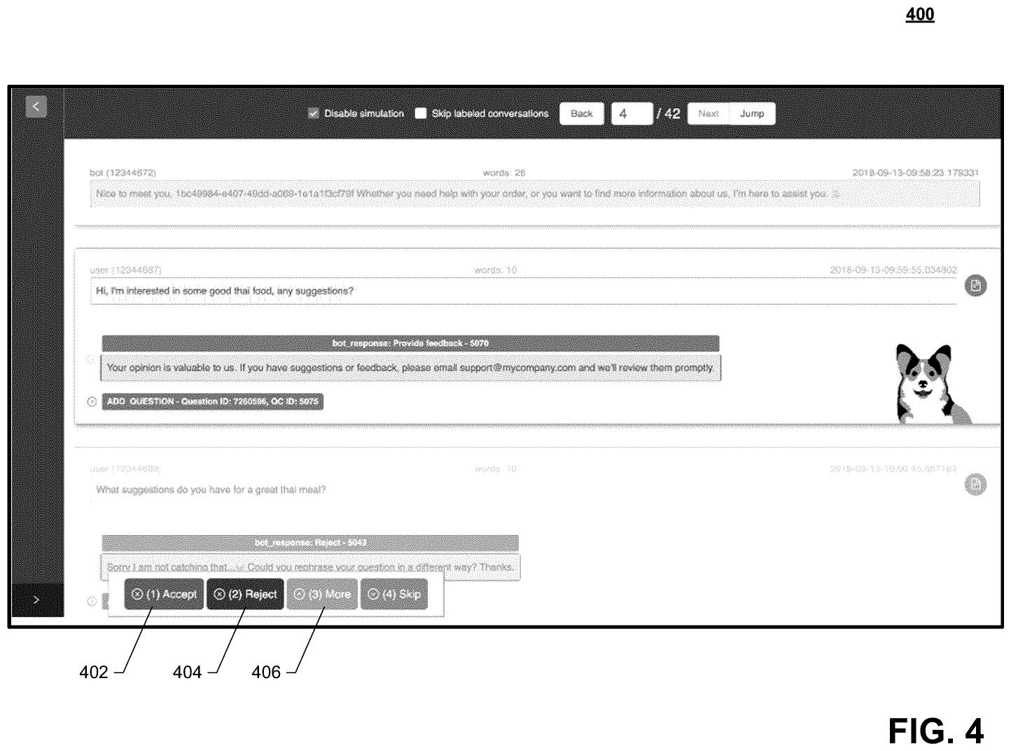

In certain embodiments, the evaluation labeling engine 306 can be configured for supervised machine learning to accept, reject, or modify one or more labels from the IT support label dataset 314. FIG. 4 illustrates an example user interface 400 associated with supervised machine learning in accordance with one or more embodiments of the present disclosure. For example, the user interface 400 can include an interactive element 402 to accept a question classification label for an IT support request, an interactive element 404 to reject a question classification label for an IT support request, and/or an interactive element 406 to modify a question classification label for an IT support request.

The active learning engine 308 can be configured to perform one or more labeling techniques with respect to the one or more service event data structures 310, the one or more historical service event data structures 311, and/or data provided by the intent recognition engine 116 to generate an IT support label dataset 316. In various embodiments, the IT support label dataset 316 can correspond to an enhanced version of the IT support label dataset 314. For example, the IT support label dataset 316 can add one or more labels to the IT support label dataset 314 and/or can augment questions of a given question class.

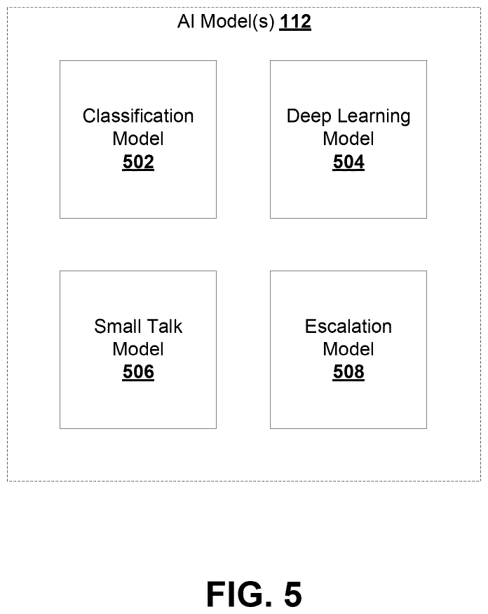

Referring now to FIG. 5, an example embodiment of the one or more AI models 112 is presented in accordance with one or more embodiments of the present disclosure. In one or more embodiments, the one or more AI models 112 include a classification model 502, a deep learning model 504, a small talk model 506, and/or an escalation model 508.

The classification model 502 can be configured to select one or more question candidates for the deep learning model 504. For example, the classification model 502 can be configured to select one or more question candidates from the one or more service event data structures 310 that are determined to be relevant a corpus of question candidates from the one or more service event data structures 310. The classification model 502 can be configured as a multi-classifier model. In various embodiments, the classification model 502 can compute a normalized classification data vector for respective question candidates. For example, the normalized classification data vector can include a normalized classification score for respective words included in one or more service event data structures. In one or more embodiments, the classification model 502 can be a TF-IDF model and/or the classification model can compute a normalized TF-IDF vector for respective question candidates. Furthermore, the classification model 502 can generate a data matrix based on the normalized classification data vector (e.g., the normalized TF-IDF vectors). Based on values of the data matrix, the classification model 502 can generate respective relevance scores for the question candidates. In certain embodiments, one or more features for the one or more question candidates selected for the deep learning model 504 can be included in the one or more training datasets 303 employed for training the deep learning model 504. In various embodiments, at least a portion of the one or more training datasets 303 can be retrieved from the training data repository 114. For example, at least training data generated by the classification model 502 can be stored in the training data repository 114.

In various embodiments, one or more training datasets 303 can include data (e.g., service event data) that is normalized and/or aggregated based on IT support intent. The one or more training datasets 303 can additionally or alternatively included one or more labels related to IT support intent. In certain embodiments, data from one or more service tickets (e.g., one or more IT service tickets) and/or related data objects can be transformed into a data format for a service conversation or one or more service messages. For example, text associated with one or more service tickets can be transformed into a data vector via one or more feature extraction techniques. The data vector can be formatted for processing by the one or more AI models 112 such as the classification model 502 and/or the deep learning model 504.

The deep learning model 504 can be configured for intent recognition. For example, the deep learning model 504 can be a neural network model (e.g., a deep neural network model) or another type of deep learning model configured for intent recognition. In various embodiments, the deep learning model 504 can be configured to determine an IT support intent classification for service event data (e.g., an IT support request). For example, the deep learning model 504 can be configured to determine an IT support label for service event data (e.g., an IT support request).

In an embodiment, the AI model training engine 302 can train the deep learning model 504 based on the one or more training datasets 303, the IT support intent classification dataset 312, the IT support label dataset 314, and/or the IT support label dataset 316. For example, the AI model training engine 302 can tune parameters (e.g., hyperparameters) and/or weights of the deep learning model 504 to learn a mapping function for intent recognition related to service event data (e.g., IT support requests). In various embodiments, the AI model training engine 302 can employ the IT support intent classification dataset 312, the IT support dataset 314, and/or the IT support label dataset 316 to train the deep learning model 504. In certain embodiments, the AI model training engine 302 can train the deep learning model 504 via a graphics processing unit (GPU). For example, the processor 202 of the AI model training apparatus 120 can be configured as a GPU, in certain embodiments, to facilitate training of the deep learning model 504.

The AI model training engine 302 can repeatedly train the deep learning model 504 until desired metrics, accuracy, and/or precision are achieved. In various embodiments, the AI model training engine 302 can employ an F1 score, a mean reciprocal rank, a mean average precision, and/or another metrics indicator to determine whether desired metrics, accuracy, and/or precision are achieved. In certain embodiments, the AI model training engine 302 can generate two or more version of the deep learning model 504 based on respective metrics indicators. For example, the AI model training engine 302 can generate a first version of the deep learning model 504 associated with an optimal accuracy, a second version of the deep learning model 504 associated with an optimal precision, a third version of the deep learning model 504 associated with an optimal F1 score, a fourth version of the deep learning model 504 associated with an optimal mean reciprocal rank, and/or a fifth version of the deep learning model 504 associated with an optimal mean average precision.

The small talk model 506 and/or the escalation model 508 can be employed by the intent recognition engine 116 in response to a determination that the deep learning model 504 is not able to successfully determine an IT support intent classification for service event data (e.g., an IT support request). For example, in certain instances, the service event data may be associated with a small talk phrase such as “how are you?” Accordingly, the small talk model 506 can be configured to determine an appropriate reply in response to a determination that the service event data satisfies small talk criteria. In another example, the service event data may be associated with a particular request to speak with a human and/or a request that infers that a conversation with a human is desirable. Accordingly, the escalation model 508 can be configured to generate a notification for a user device associated with a human support team member in response to a determination that the service event data satisfies escalation criteria. In certain embodiments, the escalation model 508 can be configured as a binary classification model (e.g., a support vector machine classifier) that classifies service event data as an escalation classification) or a non-escalation classification.

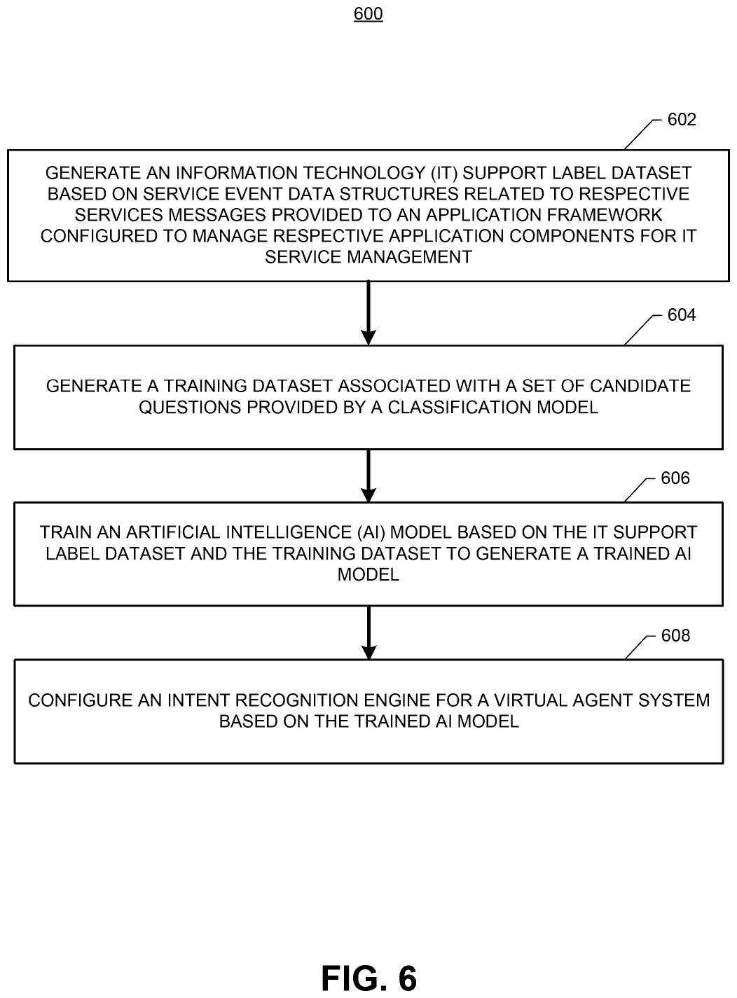

FIG. 6 is a flowchart diagram of an example process 600 for training a virtual agent AI model, in accordance with, for example, the AI model training apparatus 120. Via the various operations of process 600, the AI model training apparatus 120 can enhance efficiency, reliability and/or effectiveness of the application framework 106 and/or the virtual agent system 110.

The process 600 begins at operation 602 where an information technology (IT) support label dataset is generated (e.g., by the AI model training circuitry 212 of the AI model training apparatus 120) based on service event data structures related to respective services messages provided to an application framework configured to manage respective application components for IT service management. At operation 604, a training dataset associated with a set of candidate questions provided by a classification model is generated (e.g., by the AI model training circuitry 212 of the AI model training apparatus 120). In one or more embodiments, the classification model is configured as a TF-IDF model. In one or more embodiments, generating the training dataset includes generating the training dataset via the TF-IDF model. At operation 606, an AI model is generated (e.g., by the AI model training circuitry 212 of the AI model training apparatus 120) based on the IT support label dataset and the training dataset to generate a trained AI model. In one or more embodiments, the AI model is a deep learning model configured for intent recognition related to IT service messages. In one or more embodiments, training the AI model includes training the deep learning model based on the IT support label dataset and the training dataset to generate a trained deep learning model. The trained deep learning model can correspond to the trained AI model. At operation 608, an intent recognition engine for a virtual agent system is generated (e.g., by the AI model training circuitry 212 of the AI model training apparatus 120) based on the trained AI model.

In one or more embodiments, the AI model training circuitry 212 of the AI model training apparatus 120 performs an intent discovery process related to the service event data structures to generate an IT support intent classification dataset. In one or more embodiments, the AI model training circuitry 212 of the AI model training apparatus 120 generates the IT support label dataset based on the IT support intent classification dataset.

In one or more embodiments, the AI model training circuitry 212 of the AI model training apparatus 120 performs one or more clustering techniques with respect to data included in the service event data structures to generate the IT support intent classification dataset.

In one or more embodiments, the AI model training circuitry 212 of the AI model training apparatus 120 encodes text included in the service event data structures into embedding vectors. In one or more embodiments, the AI model training circuitry 212 of the AI model training apparatus 120 additionally or alternatively generates the IT support intent classification dataset based on the embedding vectors.

In one or more embodiments, the AI model training circuitry 212 of the AI model training apparatus 120 retrains the AI model based on an active learning process associated with a classification provided by the intent recognition engine.

In one or more embodiments, the AI model training circuitry 212 of the AI model training apparatus 120 parses service management requests related to one or more API calls into the respective services messages.

In one or more embodiments, the AI model training circuitry 212 of the AI model training apparatus 120 generates a first version of the AI model based on a first metrics indicator related to training of the AI model. In one or more embodiments, the AI model training circuitry 212 of the AI model training apparatus 120 additionally or alternatively generates a second version of the AI model based on a second metrics indicator related to the training of the AI model. In one or more embodiments, the AI model training circuitry 212 of the AI model training apparatus 120 additionally or alternatively selects the first version of the AI model or the second version of the AI model as the trained AI model for the intent recognition engine associated with the virtual agent system.

Although example processing systems have been described in the figures herein, implementations of the subject matter and the functional operations described herein can be implemented in other types of digital electronic circuitry, or in computer software, firmware, or hardware, including the structures disclosed in this specification and their structural equivalents, or in combinations of one or more of them.

Embodiments of the subject matter and the operations described herein can be implemented in digital electronic circuitry, or in computer software, firmware, or hardware, including the structures disclosed in this specification and their structural equivalents, or in combinations of one or more of them. Embodiments of the subject matter described herein can be implemented as one or more computer programs, e.g., one or more modules of computer program instructions, encoded on computer-readable storage medium for execution by, or to control the operation of, information/data processing apparatus. Alternatively, or in addition, the program instructions can be encoded on an artificially-generated propagated signal, e.g., a machine-generated electrical, optical, or electromagnetic signal, which is generated to encode information/data for transmission to suitable receiver apparatus for execution by an information/data processing apparatus. A computer-readable storage medium can be, or be included in, a computer-readable storage device, a computer-readable storage substrate, a random or serial access memory array or device, or a combination of one or more of them. Moreover, while a computer-readable storage medium is not a propagated signal, a computer-readable storage medium can be a source or destination of computer program instructions encoded in an artificially-generated propagated signal. The computer-readable storage medium can also be, or be included in, one or more separate physical components or media (e.g., multiple CDs, disks, or other storage devices).

The operations described herein can be implemented as operations performed by an information/data processing apparatus on information/data stored on one or more computer-readable storage devices or received from other sources.

The term “apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (Application Specific Integrated Circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web components, web services, web microservices, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or information/data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described herein can be performed by one or more programmable processors executing one or more computer programs to perform actions by operating on input information/data and generating output. Processors suitable for the execution of a computer program include, by way of example, both general and special purpose microprocessors, and any one or more processors of any kind of digital computer. Generally, a processor will receive instructions and information/data from a read-only memory, a random access memory, or both. The essential elements of a computer are a processor for performing actions in accordance with instructions and one or more memory devices for storing instructions and data. Generally, a computer will also include, or be operatively coupled to receive information/data from or transfer information/data to, or both, one or more mass storage devices for storing data, e.g., magnetic, magneto-optical disks, or optical disks. However, a computer need not have such devices. Devices suitable for storing computer program instructions and information/data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described herein can be implemented on a computer having a display device, e.g., a CRT (cathode ray tube) or LCD (liquid crystal display) monitor, for displaying information/data to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's query-initiating computing device in response to requests received from the web browser.

Embodiments of the subject matter described herein can be implemented in a computing system that includes a back-end component, e.g., as an information/data server, or that includes a middleware component, e.g., an application server, or that includes a front-end component, e.g., a query-initiating computing device having a graphical user interface or a web browser through which a user can interact with an implementation of the subject matter described herein, or any combination of one or more such back-end, middleware, or front-end components. The components of the system can be interconnected by any form or medium of digital information/data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits information/data (e.g., a Hypertext Markup Language (HTML) page) to a query-initiating computing device (e.g., for purposes of displaying information/data to and receiving user input from a user interacting with the query-initiating computing device). Information/data generated at the query-initiating computing device (e.g., a result of the user interaction) can be received from the query-initiating computing device at the server.

While this specification contains many specific implementation details, these should not be construed as limitations on the scope of any disclosures or of what may be claimed, but rather as description of features specific to particular embodiments of particular disclosures. Certain features that are described herein in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in incremental order, or that all illustrated operations be performed, to achieve desirable results, unless described otherwise. In certain circumstances, multitasking and parallel processing may be advantageous. Moreover, the separation of various system components in the embodiments described above should not be understood as requiring such separation in all embodiments, and it should be understood that the described program components and systems can generally be integrated together in a product or packaged into multiple products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or incremental order, to achieve desirable results, unless described otherwise. In certain implementations, multitasking and parallel processing may be advantageous.

Many modifications and other embodiments of the disclosures set forth herein will come to mind to one skilled in the art to which these disclosures pertain having the benefit of the teachings presented in the foregoing description and the associated drawings. Therefore, it is to be understood that the disclosures are not to be limited to the specific embodiments disclosed and that modifications and other embodiments are intended to be included within the scope of the appended claims. Although specific terms are employed herein, they are used in a generic and descriptive sense only and not for purposes of limitation, unless described otherwise.

That which is claimed is:

1. An apparatus comprising one or more processors and one or more storage devices storing instructions that are operable, when executed by the one or more processors, to cause the one or more processors to:
receive a service event data structure related to a service message provided to an application framework;
input the service event data structure to a first artificial intelligence (AI) model to generate an information technology (IT) support intent classification associated with the service event data structure;
compare the IT support intent classification to execution criteria for a second AI model;
in response to a determination that the IT support intent classification satisfies the execution criteria, input the service event data structure to the second AI model to generate an escalation classification associated with the service event data structure; and
cause transmission of a notification for a user device based on the escalation classification.

2. The apparatus of claim 1, wherein the execution criteria comprises first execution criteria, and wherein the one or more storage devices store instructions that are operable, when executed by the one or more processors, to further cause the one or more processors to:
compare the IT support intent classification to second execution criteria for a third AI model; and
in response to a determination that the IT support intent classification satisfies the second execution criteria, input the service event data structure to the third AI model to generate a reply message for the service message.

3. The apparatus of claim 2, wherein the user device is a first user device, and wherein the one or more storage devices store instructions that are operable, when executed by the one or more processors, to further cause the one or more processors to:
cause transmission of the reply message to a second user device associated with service message.

4. The apparatus of claim 1, wherein the second AI model is a binary classification model that classifies the service event data structure with an escalation label or a non-escalation label.

5. The apparatus of claim 1, wherein the first AI model is a non-binary classification model and the second AI model is a binary classification model.

6. The apparatus of claim 1, wherein the first AI model is a deep learning model trained for intent recognition related to IT service messages.

7. The apparatus of claim 1, wherein the first AI model is trained based on a training dataset that comprises one or more historical services messages for a user identifier associated with the service message.

8. The apparatus of claim 1, wherein the first AI model is trained based on a training dataset associated with a set of candidate questions provided by a classification model.

9. A computer-implemented method, comprising:
receiving a service event data structure related to a service message provided to an application framework;
inputting the service event data structure to a first artificial intelligence (AI) model to generate an information technology (IT) support intent classification associated with the service event data structure;
comparing the IT support intent classification to execution criteria for a second AI model;
in response to a determination that the IT support intent classification satisfies the execution criteria, inputting the service event data structure to the second AI model to generate an escalation classification associated with the service event data structure; and
causing transmission of a notification for a user device based on the escalation classification.

10. The computer-implemented method of claim 9, wherein the execution criteria comprises first execution criteria, and the computer-implemented method further comprises:
comparing the IT support intent classification to second execution criteria for a third AI model; and
in response to a determination that the IT support intent classification satisfies the second execution criteria, inputting the service event data structure to the third AI model to generate a reply message for the service message.

11. The computer-implemented method of claim 10, wherein the user device is a first user device, and the computer-implemented method further comprises:
causing transmission of the reply message to a second user device associated with service message.

12. The computer-implemented method of claim 9, wherein the second AI model is a binary classification model that classifies the service event data structure with an escalation label or a non-escalation label.

13. The computer-implemented method of claim 9, wherein the first AI model is a non-binary classification model and the second AI model is a binary classification model.

14. The computer-implemented method of claim 9, wherein the first AI model is a deep learning model trained for intent recognition related to IT service messages.

15. The computer-implemented method of claim 9, wherein the first AI model is trained based on a training dataset that comprises one or more historical services messages for a user identifier associated with the service message.

16. The computer-implemented method of claim 9, wherein the first AI model is trained based on a training dataset associated with a set of candidate questions provided by a classification model.

17. A computer program product, stored on a computer readable medium, comprising instructions that when executed by one or more computers cause the one or more computers to:
receive a service event data structure related to a service message provided to an application framework;
input the service event data structure to a first artificial intelligence (AI) model to generate an information technology (IT) support intent classification associated with the service event data structure;
compare the IT support intent classification to execution criteria for a second AI model;
in response to a determination that the IT support intent classification satisfies the execution criteria, input the service event data structure to the second AI model to generate an escalation classification associated with the service event data structure; and
cause transmission of a notification for a user device based on the escalation classification.

18. The computer program product of claim 17, wherein the execution criteria comprises first execution criteria, and the computer program product further comprising instructions that when executed by the one or more computers cause the one or more computers to:
compare the IT support intent classification to second execution criteria for a third AI model; and
in response to a determination that the IT support intent classification satisfies the second execution criteria, input the service event data structure to the third AI model to generate a reply message for the service message.

19. The computer program product of claim 18, wherein the user device is a first user device, and the computer program product further comprising instructions that when executed by the one or more computers cause the one or more computers to:
cause transmission of the reply message to a second user device associated with service message.

20. The computer program product of claim 17, the computer program product further comprising instructions that when executed by the one or more computers cause the one or more computers to:
receive a service event data structure related to a service message provided to an application framework;
input the service event data structure to a first artificial intelligence (AI) model to generate an information technology (IT) support intent classification associated with the service event data structure;
compare the IT support intent classification to execution criteria for a second AI model;
in response to a determination that the IT support intent classification satisfies the execution criteria, input the service event data structure to the second AI model to generate an escalation classification associated with the service event data structure; and
cause transmission of a notification for a user device based on the escalation classification.
